(19) United States
(12) Patent Application Publication
(10) Pub. No.: US 2011/0173853 A1
(43) Pub. Date: Jul. 21, 2011

(54) BILLBOARD SYSTEM AND METHODS OF USE THEREOF

(76) Inventor: Christophe Leveque, Old Saybrook, CT (US)

(21) Appl. No.: 12/691,581

(22) Filed: Jan. 21, 2010

(51) Int. Cl. G09F 13/00; G09F 15/00; H02J 7/34; F03D 9/00; H02P 9/04

(52) U.S. Cl. 40/541; 40/624; 290/50; 290/55; 290/44

(57) ABSTRACT

Disclosed herein is an improved billboard system and method of use thereof. One or more vertical axis wind turbines (VAWT) are mounted onto the top portions of posts supporting new or previously constructed billboards. The vertical axis wind turbines, which are configured to rotate regardless of the direction of the wind, generate electrical power that is used to provide the power needs of lighting display elements (lights, screens, etc.) found on the billboard. The turbines are also used to charge batteries that may later be used to supply power to the billboard during periods when the turbines do not generate sufficient power or when one or more of the turbines are not operational. Surplus power not used to power the display elements or charge the batteries may be transmitted to the utility power grid. The billboard system may be monitored and controlled from a remote location via a communications network.

### TECHNICAL FIELD OF THE INVENTION

The present invention relates to improved billboard systems having vertical axis wind turbines mounted thereon for providing the electrical power needs of the billboard and for generating surplus power. The system takes advantage of the pre-existing structures and power grid attachment points.

### BACKGROUND OF THE INVENTION

“Billboard” is the common term used to describe a type of outdoor advertising found along major highways. This name is most frequently given to large steel-framed signs, which are mounted on poles 20-100 ft (6.1-30.5 m) above the ground. Most often, the sign is printed on large poster sheets, which are affixed to the face of the sign. These signs may also be equipped with a variety of special lighting and display effects. This type of sign is one component of a unique advertising medium that communicates to audiences on the go. As recently as 25 years ago, 90% of outdoor advertising consisted of billboards. The Federal Highway Administration estimates that in 1996 there were over 400,000 billboards on federally controlled roads, which generated revenues in excess of $1.96 billion.

Born out of necessity, billboards were probably first used to convey a message to the majority of individuals who were illiterate. The oldest known billboard ad was posted in the Egyptian city of Thebes over 3,000 years ago and offered a reward for a runaway slave. Prior to the late 1700s, the predecessor to the modern day billboard—billposting—was prevalent throughout Europe, but only as an informal source of information. It was not until the invention of lithography in the late eighteenth century that billboards as a medium expanded into an art form. The first large scale use of the billboard as an advertising tool was as circus posters printed or secured on horse-drawn trucks that would precede a show to town in order to increase interest and attendance. At this time, billboards were not standardized or controlled by any laws. During 1872-1912, organizations in the United States met to create billboard standards. Originally, the standard set was 24-sheet poster panels with a total size of 19.5×8.7 ft (6×2.6 m). Today, that size remains the same, while technology has reduced 24 sheets to 10.

During the early 1900s, electric billboards were used to light up cities. Prior to the electric billboard, cities were dark, foreboding places. The electric bill-board brought the cities to life at night, creating a more hospitable atmosphere that induced people to stay on the streets. However, this has also made it standard to have a connection between the billboard and the electrical grid.

Construction of the billboard typically starts when a steel erection company orders all the support components required for the job. Upon receipt of the components, they bolt and weld together as many pieces as possible before shipping them to the job site. Some of the longer steel pipes may be connected together as telescoping sections. Pre-assembly saves time on the job site and improves ease of shipping. The pre-assembled parts are then transported to the job site by truck. The job site must be properly prepared prior to installation of the steel. A subcontractor is typically assigned to drill a hole in the ground in which to place the support post. Approximately 20-30 ft (6.1-9.1 m) deep, the hole is filled with concrete and the support post is put into place. This ensures that the structure is sturdy and able to withstand high wind conditions.

Next, the frame is bolted into place on top of the post which may be as little as 20 ft (6.1 m) or as much as 100 ft (30.5 m) above the ground. The term haggle is used to describe the distance from the sign face to ground level. The frame is equipped with catwalk-style walkways to allow access to the surfaces where the advertising elements are mounted. These catwalks may run along the front as well as the back of the sign with an access ladder located in the rear. The walkways are also built with attachments for safety cables used by the workers. The entire installation process takes a crew of three or four men approximately one week to complete.

Typically, local electrical contractors are hired to install the power and lighting systems. In many cases, both sides of the sign are used for artwork, so lighting assemblies are required for both sides. In addition, the sign may require special wiring to operate moving parts or other special effects. All wiring must be done in accordance with relevant electrical codes. The costs associated with providing power to the lighting systems of a billboard can be substantial.

During the past decade, there has been a strong push to implement alternative energy solutions. For example, wind turbines are being erected throughout the central part of the United States where wind speeds are sufficiently strong and consistent to make the turbines economical. One of the primary costs of a wind turbine is the support structure, or mast, used to elevate the turbine blades to a suitable height. The mast is an expensive structure to build, transport, and erect. A need exists for a method of simplifying the erection of wind turbines. The need also extends to reducing the costs of placing the turbines at suitable heights, thereby making their use more widespread and affordable. Moreover, a need exists for a cost effective means for supplying power to electric billboards. Therefore, it is the object of the present invention disclosed herein to meet the above needs and other needs not met by billboard systems and methods found in the prior art.

### BRIEF SUMMARY OF THE INVENTION

Accordingly, there is provided herein, in various embodiments, an improved billboard system having mounted thereon, one or more vertical axis wind turbines for supplying power to said billboard and for providing surplus power that may be transmitted to an existing electrical grid. In one aspect of the invention, one or more vertical axis wind turbines are mounted to posts that serve as supports for a new or previously constructed billboard. The turbines are mounted on the top portion of the posts such that no part of the advertising surface or other advertising medium deflects wind flowing into the turbine. Various types of vertical axis wind turbines may be implemented with respect to the present invention, including, but not limited to, Darrieus, Savonius, Gorlov, and helical type turbines.

In another aspect of the present invention, a plurality of advertising surfaces may be implemented in connection with the improved billboard system. By way of example, and not of limitation, two advertising surfaces may be connected at ends of the respective surfaces such that an angle exists between the two surfaces. Wind turbines may then be mounted on the support posts supporting the aforesaid surfaces such that an increased number of total wind turbines may be mounted on one billboard structure.

In yet another aspect of the present invention, the vertical axis wind turbines mounted on support posts as described above, produce an alternating current that is rectified into a direct current by means of an AC/DC converter that is connected to the turbines. The direct current outputted from the converter is then used to supply power to the billboard as well as to charge one or more batteries housed within or adjacent to the billboard. The batteries may be used to provide electrical power to the billboard during periods when the turbine(s) are not generating sufficient power to meet the billboard's power needs or when the turbines are in need of repair or other maintenance.

In yet another aspect of the invention, a DC/AC inverter is connected to the one or more vertical axis wind turbines such that when surplus electrical power is being generated by the turbines, electrical current may be transformed into alternating current suitable for transmission onto existing utility power grids. An electrical utility circuit breaker also provides for safe transmission of electricity from the billboard structure to the power grid and for transmission of electricity to the billboard structure. One or more electrical meters may be utilized to detect the amount of energy being transmitted to and from the billboard structure. One or more security boxes housing control systems necessary to monitor and control the distribution of electrical power into and out of the turbines and the billboard structure itself are utilized. One or more of the security boxes may house a billboard control system that is capable of communicating with persons or systems via a communications/data network and thus, permit control and monitoring of the billboard system from a remote location.

### BRIEF DESCRIPTION OF THE SEVERAL VIEWS OF THE DRAWINGS

A more complete understanding of the present invention may be had by reference to the following detailed description when taken in conjunction with the accompanying drawings, wherein:

FIG. 1A shows a front view of a preferred embodiment of the improved billboard system of the present invention having a helical Darrieus type vertical axis wind turbines;

FIG. 1B shows a top view of the improved billboard system shown in FIG. 1A;

FIG. 2A shows a front view of an alternate embodiment of the improved billboard system of the present invention having helical type vertical axis wind turbines;

FIG. 2B shows a top view of a the improved billboard system shown in FIG. 2A;

FIG. 3A shows a front view of yet another alternate embodiment of the improved billboard system of the present invention having a plurality of advertising surfaces;

FIG. 3B shows a top view of the improved billboard system shown in FIG. 3A; and

FIG. 4 shows a block diagram illustrating many of the major electrical components of a preferred embodiment of the improved billboard system of the present invention.

Where used in the various figures of the drawings, the same numerals designate the same or similar parts. Furthermore, when the terms “front,” “back,” “top,” “first,” “second,” “upper,” “lower,” “height,” “outer,” “inner,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific width, length, and similar requirements will likewise be within the skill of the art after the following teachings of the present invention have been read and understood.

Preferred embodiments of the improved billboard system (and methods of use thereof) according to the present invention will now be described in detail with reference to the accompanying drawings.

### DETAILED DESCRIPTION OF THE SEVERAL VIEWS OF THE DRAWINGS

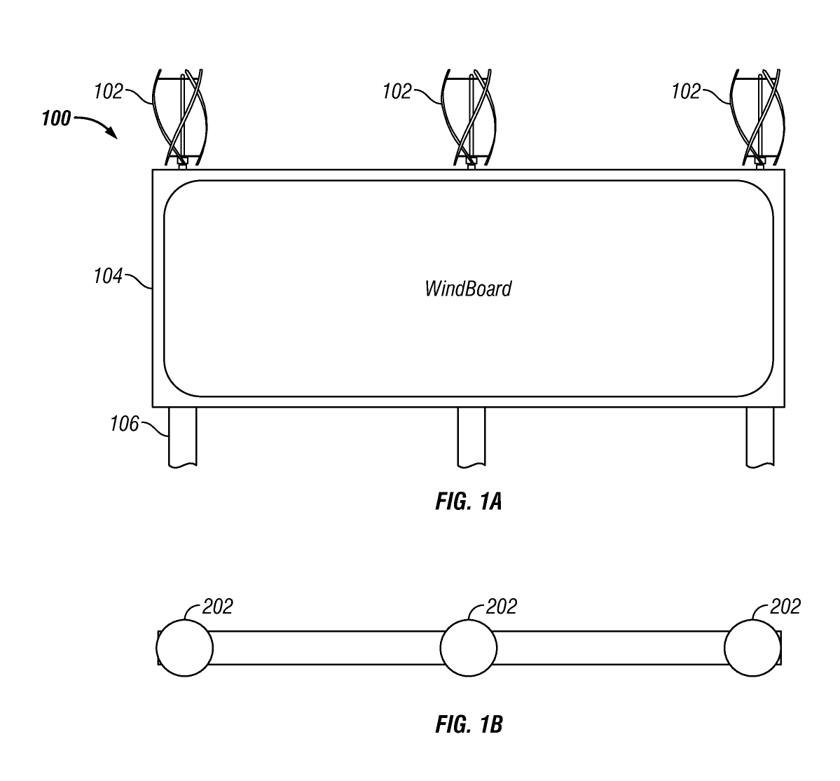

Referring to FIG. 1A, a front view of a preferred embodiment of the improved billboard system 100 of the present invention, the primary structural elements thereof are support posts 106 that are configured to support an advertising surface 104 or “windboard,” and a plurality of helical Darrieus type vertical axis wind turbines 102 that are mounted on the top portions of the posts 106. The support posts 106 may be secured by insertion of the bottom of the post (not shown) directly into the ground or by means of a concrete pier or helix piling. The manner in which the posts 106 are anchored into the ground may be chosen after considering the firmness of the soil or other surface upon which the posts will rest. Alternatively, the post 106 or other support structure means may be connected to another supporting structure such as the side or roof of a building. While the presently preferred embodiment of the billboard system 100 disclosed herein includes a plurality of supporting posts 106, it is contemplated that less than a plurality of posts may be utilized in alternate embodiments of the billboard system 100. In fact, it is contemplated that no posts may be used to support the windboard 104, but rather, that the windboard 104 may be supported by any support structure means suitable for bearing the load of the windboard 104 and turbines 102. Examples of such other support structure means include, but are not limited to, beams, cables, poles, monopiles, jacket structures, tripod structures, and buildings.

Referring still to FIG. 1A, the windboard 104 is mounted onto the support posts 106 such that said posts 106 bear the load of the windboard 104 and limit any movement resulting from the force of wind directed onto the surfaces thereof. The posts 106 may also serve to support any electrical conduits that are necessary to transmit electrical power to and from the billboard system 100, including the turbines 102 and other display elements. The windboard 104 itself may be constructed from any number of common materials used to construct billboards known in the prior art, including, but not limited to, a steel frame, fabric, and lighting or screen elements. It is well known by those having ordinary skill in the art that advertising surfaces used in connection with billboards may utilize light emitting diodes (LEDs) to produce various lighting effects. For example, LED screens used in connection with billboards are often capable of displaying moving video, text, and other images. The aforementioned screens and other lighting effects utilized in connection with billboards require a relatively substantial amount of power to operate. It is contemplated that such screens and other lighting effects may be used in connection with the present invention.

One of the functions of the vertical axis wind turbines 102 that are mounted onto the tops of the support posts 106 is to generate at least a portion of the electrical power necessary to meet the electrical power needs of the electrical lighting display elements of the windboard 104. It should be noted that various types of vertical axis wind turbines may be utilized in alternate embodiments of the invention. For example, Savonius and Gorlov type vertical axis wind turbines may be utilized in alternate embodiments of the present invention.

One advantage of utilizing vertical axis wind turbines such as the helical turbines used in the preferred embodiment is that they are configured to operate, that is, to rotate, regardless of the direction from which the wind blows. Another advantage of utilizing vertical axis wind turbines is that their operation is relatively noiseless in comparison to the noise produced by some other types of wind turbines. Consequently, when implemented in connection with the present invention, the turbines do not generate excessive noise pollution that would otherwise detract from the quality of the surrounding environment. A further advantage of utilizing vertical axis wind turbines is that by the very nature of their design, they are compact and thus, only require limited space in which to operate.

While the preferred embodiment of the present invention utilizes three wind turbines 102, alternate embodiments of the invention may only include one or two turbines mounted onto the billboard. Further, other alternate embodiments may include more than three turbines mounted on the billboard. It will be recognized by those having ordinary skill in the art that the number of turbines used in connection with any particular billboard system may be chosen after giving consideration to a number of factors. Such factors may include the costs of the turbine itself, the costs of maintaining the turbine, the electrical power needs of the billboard, and the suitability of the location of the billboard with respect to the amount of wind to which such location is exposed.

The wind turbine 102 is ideally to be mounted on the top portion of the support posts 106 such that the blades of the turbine 102 are not in any way shielded from wind flow by the windboard 104. Those of ordinary skill it the art will recognize that it may be necessary to consider the particular size and shape of the windboard 104 being used when determining the precise mounting location of the turbine, including how high above the windboard 104 the turbine 102 should be mounted. The foregoing consideration is necessary because the size and shape of the windboard may work to deflect varying amounts of wind away from the turbines. This effect should be minimized to the extent reasonably possible. FIG. 1B shows a top view of the billboard structure shown in FIG. 1A.

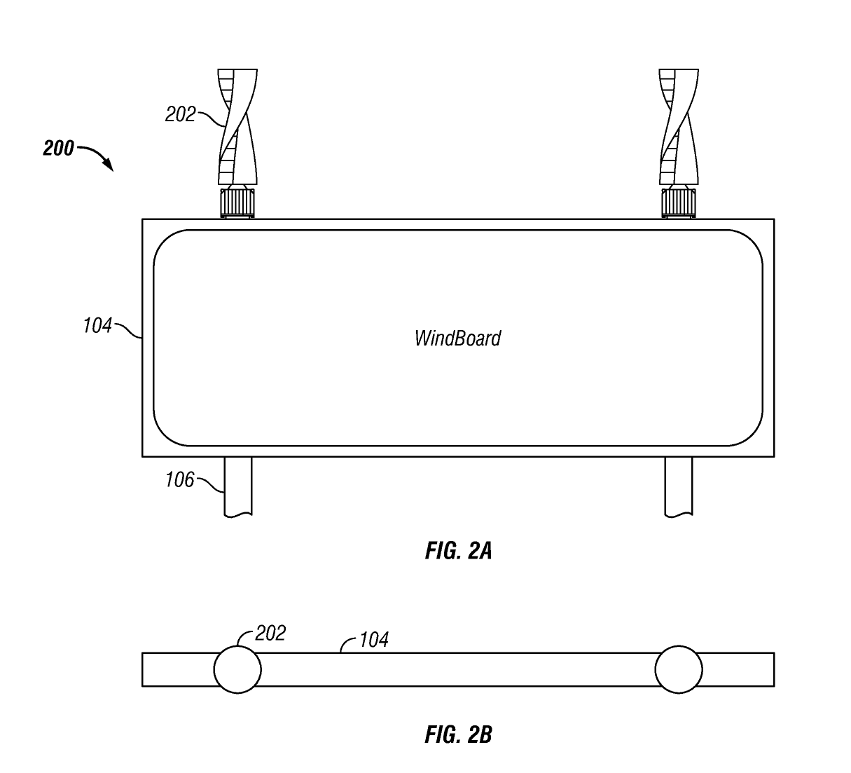

Referring now to FIG. 2A and FIG. 2B, front and top views, respectively, of an alternate embodiment of the improved billboard system 200 of the present invention. As discussed above, it is contemplated that various types of vertical axis wind turbines may be implemented in connection with the improved billboard structure of the present invention. The alternate embodiment of the billboard system 200 shown in FIG. 2A includes helical type wind turbines 202 that are mounted onto the tops of support posts 106. Differing types of vertical axis wind turbines, such as helical, Savonius, and Gorlov turbines, may offer advantages in initial costs and operating costs not present in other types of vertical axis wind turbines. Moreover, differences in efficiency amongst differing types of vertical axis wind turbines should also be considered when determining which type of turbine to implement in connection with the present invention.

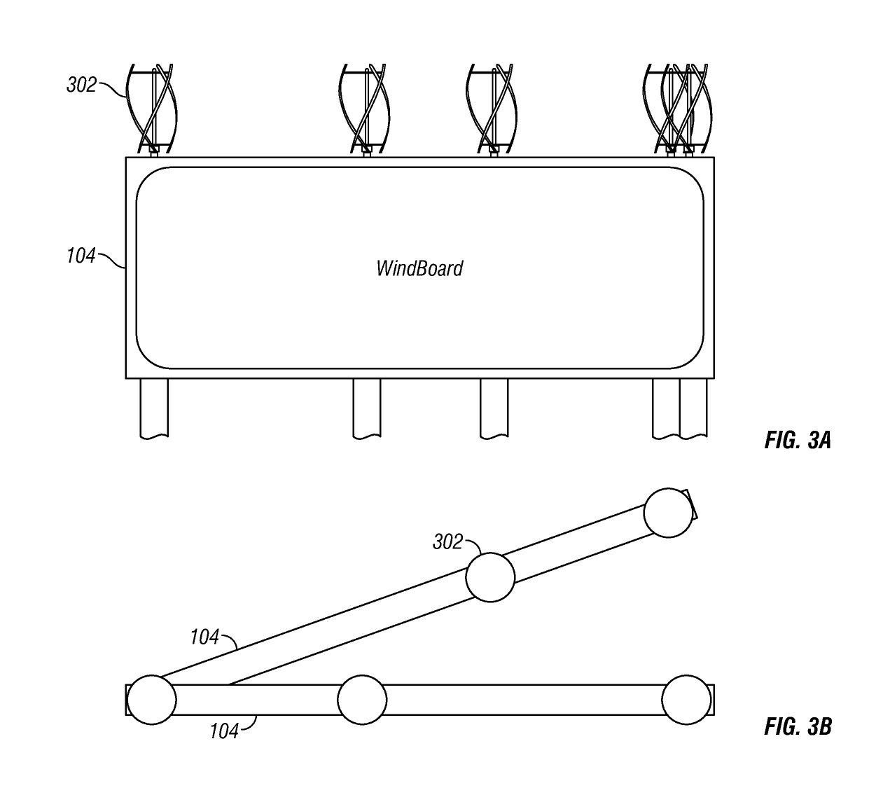

Referring now to FIG. 3A and FIG. 3B, front and top views, respectively, of yet another alternate embodiment 302 of the improved billboard system of the present invention. It is contemplated that the billboard system of the present invention may also include a plurality of windboards 104. As is shown in FIG. 3B, two windboards may share a common support post 106. The aforesaid two windboards may then be mounted on other support posts such that an angle exists between said windboards. This configuration provides for increased viewing exposure of advertisements featured on the windboards. Like the embodiments of the billboard discussed herein above, turbines are mounted on the top portions of the support posts and thus, an increased number of turbines may be implemented in connection with the billboard system. Accordingly, this results in an increase in the amount of electrical power that may be generated.

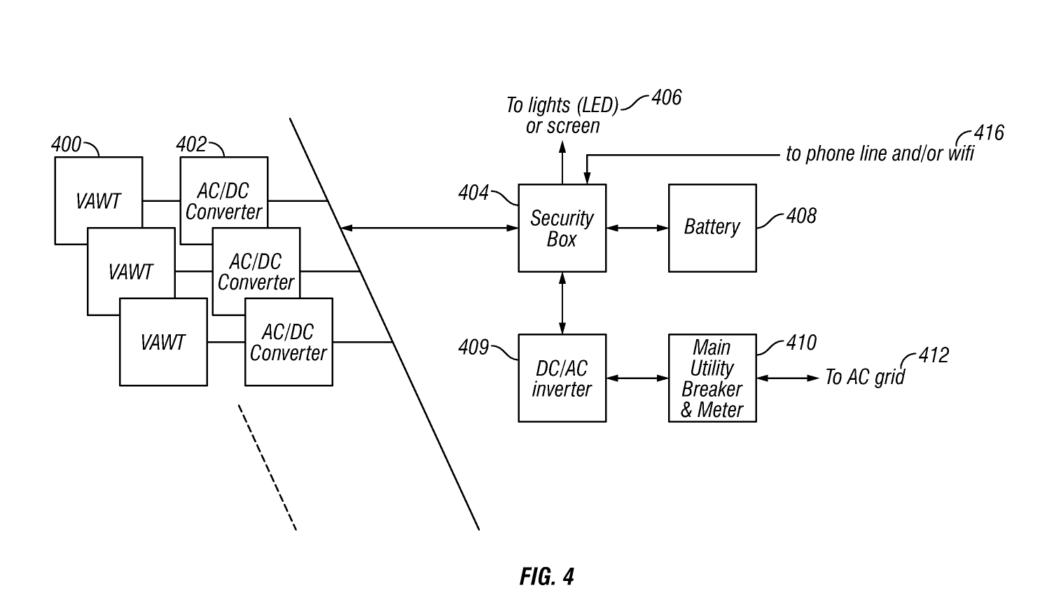

Referring now to FIG. 4, a block diagram showing many of the major electrical components of a preferred embodiment of the improved billboard system of the present invention. The blades of the vertical axis wind turbines 400 are configured to rotate when they are exposed to wind. The rotation of the blades rotates a shaft which is connected to an electromechanical device such as an alternator (not shown) to produce an alternating current. The alternating current is then rectified into direct current by means of an AC/DC converter 402 such that the current is suitable for use with other electrical components housed within the billboard or otherwise connected thereto. It is contemplated that alternate embodiments of the billboard may utilize a generator connected to the turbine to produce direct current.

Direct current outputted from the AC/DC converter 402 is transmitted to a security box 404 which houses a control system unit necessary to control transmission of electrical power from the turbines to other electrical componentry within the billboard, as well as to an external power source such as a utility power grid 412 via an electrical transmission line. The security box is in turn connected to one or more batteries 408 that are capable of being charged by the power generated by the turbines 400. Also connected to the security box 404 are lights, a screen 406, or any other electrical element (collectively, “the display elements”) that requires electrical power.

The control system unit housed within the security box 404 includes one or more controllers, switches, and sensors adapted for detecting the amount of power outputted from the turbines, the power required to operate the display elements, and the amount of charge on the batteries. The control system unit constantly monitors the power being generated by the turbines and the power needs of the display elements. If insufficient power is being generated by the turbines to power the display elements, the control system will switch to the battery for supplying the electrical power needs of said display elements 406. It is contemplated that during the day, energy generated by the wind turbines is stored within the battery or any other type of energy storage device (air battery, spinning flywheels, etc.). The energy stored in the battery may then be used at night to operate the lighting display elements. The control system unit 404 is also connected to the external utility power grid 412, which can supply power to the display elements if neither the charge of the batteries or the power generated by the wind turbines is sufficient.

The external utility power grid is connected to a main utility breaker box and electric meter 410 which is in turn, connected to the billboard. Alternating current from the power grid may be utilized to provide power to the display elements 406 if necessary. Conversely, if the wind turbines generate surplus power such that the amount of power generated exceeds the power requirements of the display elements and what is necessary to charge the batteries 408, such surplus power may be transmitted to the A/C power grid or some other remote location. An DC/AC inverter 409 is utilized to convert the direct current from the security box 404 into an alternating current of a magnitude and frequency that is suitable for transmission on the utility power grid 412. Likewise, a rectifier (not shown) may be used to convert alternating current from the utility power grid to direct current to power the display elements. The electrical meter 410 measures the amount of electrical power from the utility power grid that is consumed by the billboard. An electrical meter 410 may also be used to measure the amount of power that is transmitted to the utility power grid 412.

The control system unit housed in the security box 404 also contains additional communications systems that may be used to control operation of the billboard from a remote location. The security box 404 (and control system unit housed within) may be connected to a public switched telephone network, the internet, a wireless network, a local area network, or any other data or other communications network 416. This connection permits persons and systems remote from the billboard to monitor and control operation of the billboard, including the turbines, and display elements, batteries, and control systems therein. For example, it may be desirable to monitor and record the amount of power being generated by the turbines so that decisions can be made as to whether the number of turbines mounted on the particular billboard system should be increased or decreased. Likewise, it may be desirable to monitor the operation of the turbines to determine whether one or more of the turbines has been damaged or is need of maintenance. Further, it may be desirable to monitor the amount of power from the utility power grid is being used by the billboard or how much surplus power from the turbines is being transmitted to the utility power grid. It will be recognized by those skilled in the prior art that other uses may be made of the present invention's ability to be remotely monitored and controlled via a communications/data network.

The improved billboard system of the present invention may be used in connection with an energy efficient method of advertising media content. Instead of drawing power exclusively from a utility power grid to meet the power requirements of a billboard, the wind turbines of the present invention provide at least a portion, if not all, of the power needs of the billboard. This capability substantially reduces the costs of operating a billboard and conserves energy resources. Moreover, the capability of the improved billboard system of the present invention to transmit surplus power via electrical transmission lines permits the user of the system to sell excess energy to utility companies and thus, gain revenue. The transmission of excess energy may also provide a basis upon which a user of the present invention may gain credits in connection with CO2 certificate trading.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

I claim:

1. An improved billboard system comprising:
a.) one or more support posts supporting at least one advertising surface; and
b.) one or more wind turbines mounted on said billboard system, said one or more wind turbines capable of generating electrical current that is directed to a control systems unit for controlling electrical power utilized in said billboard system; said control systems unit also being connected to an electrical transmission line that is in turn connected to an external power source;
wherein said electrical transmission line is capable of supplying electrical current to said billboard system and also capable of receiving electrical current generated by said one or more wind turbines and transmitting said electrical current to a remote location.

2. The improved billboard system of claim 1, further comprising at least one battery that is electrically connected to said control systems unit.

3. The improved billboard system of claim 1, further comprising a current rectifier connected to said one or more wind turbines and adapted for converting alternating electrical current generated by said one or more wind turbines to direct electrical current.

4. The improved billboard system of claim 1 wherein said direct current outputted by said current rectifier is directed to said control systems unit and is further directed by said control systems unit to said at least one battery.

5. The improved billboard system of claim 1, further comprising a current inverter connected to said control systems unit and adapted for converting direct electrical current to alternating electrical current for transmission onto said electrical transmission line.

6. The improved billboard system of claim 1 wherein said one or more wind turbines are vertical axis wind turbines (VAWT) of a type selected from the group consisting of: helical Darrieus, Savonius, Gorlov, and helical type wind turbines.

7. The improved billboard system of claim 1 wherein said control systems unit is capable of transmitting and receiving information from one or more remote locations via a communications network.

8. The improved billboard system of claim 7 wherein information associated with the operation of the billboard system may be transmitted by said control systems unit to said one or more remote locations via said communications network.

9. The improved billboard system of claim 7 wherein information for controlling operation of said billboard system may be transmitted from said one or more remote locations to said control unit via said communications network and wherein said control systems unit operates said billboard system in accordance with commands included in said information.

10. The improved billboard system of claim 1 wherein two or more advertising surfaces are coupled to, and supported by, one of said support posts.

11. The improved billboard system of claim 1 wherein said one or more wind turbines are mounted on the top portions of said one or more support posts.

12. The improved billboard system of claim 1, further comprising electrical display elements wherein electrical power generated by said one or more wind turbines supplies at least a portion of the power requirements needed to operate said electrical display elements.

13. An improved billboard system comprising:
a.) a windboard adapted for displaying advertising content;
b.) a support structure means for supporting said windboard; and
c.) at least one wind turbine mounted on, and electrically connected to, said billboard system wherein electrical current from said at least one wind turbine is directed to a control system unit;
wherein said control system unit is communicatively coupled to a communications network and adapted to transmit and receive signals associated with the operation of said billboard system over said communications network.

14. The improved billboard system of claim 13 wherein said windboard includes lighting display elements for visually advertising media content.

15. The improved billboard system of claim 14 wherein at least a portion of the power supply needs necessary to operate said lighting display elements are generated by said at least one wind turbine.

16. The improved billboard system of claim 13 wherein said control systems unit is electrically connected to an electrical transmission line and is capable of directing electrical current generated by said at least one wind turbine onto said electrical transmission line for transmission to a remote location.

17. An energy efficient method of advertising media content comprising the following steps:
a.) providing an improved billboard system having a windboard adapted for displaying advertising content;
b.) providing a support structure means for supporting said windboard; at least one wind turbine mounted on, and electrically connected to, said billboard system wherein electrical current from said at least one wind turbine is directed to a control system unit; said control systems unit also being connected to an electrical transmission line that is in turn connected to an external power source;
wherein said electrical transmission line is capable of supplying electrical current to said billboard system and also capable of receiving electrical current generated by said one or more wind turbines and transmitting said electrical current to a remote location.

18. The energy efficient method of advertising media content of claim 17 wherein said control systems unit is capable of transmitting and receiving information from one or more remote locations via a communications network.

19. The energy efficient method of advertising media content of claim 18, further comprising the step of said control systems unit transmitting information associated with the operation of said improved billboard system to a remote location via a communications network.

20. The energy efficient method of advertising media content of claim 18, further comprising the step of said control systems unit receiving information associated with the operation of said improved billboard system from a remote location via a communications network wherein said control systems unit operates said billboard system in accordance with said information.
